(19) United States
(12) Patent Application Publication
(10) Pub. No.: US 2008/0071788 A1
(43) Pub. Date: Mar. 20, 2008

(54) METHOD FOR MEMBERSHIP PROPOGATION WITH MEMBERSHIP-PATTERN EXCEPTION DETECTION

(75) Inventor: Michael Muller, Medford, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/532,594

(22) Filed: Sep. 18, 2006

(51) Int. Cl. G06F 17/30

(52) U.S. Cl. 707/9

(57) ABSTRACT

A method, article, and system for monitoring the granting of access rights to objects and files during the execution of new membership to an activity thread or an activity, which constitutes the propagation of the new membership across multiple objects. When a user executes the “propagate” command or function, the environment examines the membership access control list (ACL) of all the objects in the collection, and determines if one or more objects posses a membership list that is different from the membership lists of the other objects within the collection. These “exceptional” objects present “exceptions” to the general pattern of membership. The system queries the user as to whether it is desirable to add the new member to each “exceptional” object.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to electronic software that manages objects or file structures with conditional or rights access, and more particularly to providing a method, article, and system for monitoring the granting of access rights to objects and files during the execution of new membership to an Activity Thread or an Activity, which constitutes the propagation of the new membership across multiple objects.

2. Description of the Related Art

Electronic programs employing activity-centric collaboration have become a central feature of modern life and have become quite prevalent in and out of the work environment. Activity-centric collaboration refers to a situation where groups of people share a collection of online objects (broadly defined to include any file, resource, communications instance, website, etc.), artifacts, or documents, and in which membership may be specified independently for each object in the collection. In some instances, all members of the group have access to all objects, and in others subgroups form and maintain relatively restrictive or private access to a subset of those objects. For example, a team my share project-related documents, but the team lead and one member of the team may have a side conversation (e.g., in a chat or a discussion thread) that is private from the rest of the team.

Programs such as International Business Machines ActivityExplorer (AE) and Unified Activity Management (UAM) provide an environment and a means for sharing objects with a large group, and for more restricted sharing of objects among two or a few people. In AE, a group may co-construct a tree-structured collection of diverse shared objects called an Activity Thread. In UAM, a group may co-construct a tree-structured collection of task/activity descriptions, called an Activity, with other, non-task objects attached to those task descriptions as resources. Both AE and UAM provide a means for restricting access on selected objects. Thus, in both AE and UAM, it is possible to share many objects (herein referred to as “team-public” objects) in the collection with all team members, and also to restrict access on a subset of objects (herein referred to as “private” objects) to two or even one member.

A problem may arise when a new member is added to a group or a team. Both AE and UAM allow the new member to be added to the ACL (access control list) of a single object. However, it is often necessary to share the general work of the team with the new member, and so both AE and UAM provide a method for adding the new member to the ACLs of all of the objects in that collection. This method is referred to as propagation: The operation of adding the new member to an object is propagated to all other objects in the Activity Thread (AE) or Activity (UAM). The problem arises when the Activity Thread or Activity contains both team-public objects and private objects. The method of adding the member to all objects does not distinguish between these two classes of objects, and automatically adds the new member to both the team-public and the private objects. It is not necessarily desirable for the new member to have access to the private objects.

The present invention is directed to addressing, or at least reducing, the effects of, one or more of the problems set forth above, by giving the user of electronic programs employing activity-centric collaboration a means for enhanced controls when a new member is being granted access to all the objects in an Activity Thread or an Activity—i.e., during propagation of the new membership across multiple objects. When a user executes the “propagate” command or function, the environment examines the membership list (ACL) of all of the objects in the collection, and discovers one or more objects whose membership list is different from the membership lists of the other objects. These “exceptional” objects present “exceptions” to the general pattern of membership. The system queries the user as to whether it is desirable to add the new member to each “exceptional” object.

### SUMMARY OF THE INVENTION

Embodiments of the present invention include a method for a current member to selectively add a new member to an activity-centric collaboration, where groups of people share a collection of objects, which have access control lists. The method further comprises an application monitoring the granting of access rights to the objects during execution of new membership to an activity thread or an activity that constitutes the propagation of new membership across multiple objects. The access control lists further comprise membership lists that have a listing that identifies individual members within the groups of people. When a current member executes a new membership propagate command, the application examines the membership list of the objects in the collection, and when the application discovers one or more objects whose membership list is different from the membership lists of the other objects, the objects are considered to be exceptional objects to the general pattern of membership, and the application queries the user as to whether it is desirable to add the new member to each of the exceptional objects. The objects within the activity-centric collaboration may comprise a file, communications instance, website, artifacts, or documents. In addition, the objects can be public or private objects, where public objects are available to everyone within the group, but private objects are restricted to a subset of people within the group.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system for practicing one or more embodiments of the present invention.

FIG. 2 is a flow diagram illustrating a first embodiment of the present invention.

FIG. 3 is a flow diagram illustrating a second embodiment of the present invention.

The detailed description explains the preferred embodiments of the invention, together with advantages and features, by way of example with reference to the drawings.

### DETAILED DESCRIPTION OF SPECIFIC EMBODIMENTS

It is the object of the present invention to provide a method and means for controlling membership propagation, when a new member is being granted access to all the objects in a group of objects. When a user (current member) executes the “propagate” command or function, the environment examines the membership list (ACL) of all of the objects in the collection, and discovers one or more objects whose membership list is different from the membership lists of the other objects. These “exceptional” objects present “exceptions” to the general pattern of membership. The system queries the user as to whether it is desirable to add the new member to each “exceptional” object.

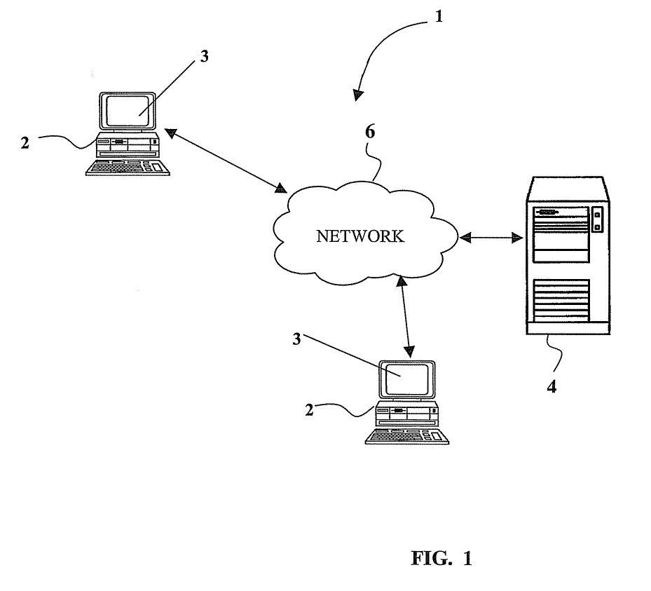

Turning now to the drawings, FIG. 1 is a block diagram of an exemplary system for implementing the electronic activity-centric collaboration program of the present invention and graphically illustrates how those blocks interact in operation. The system includes one or more computing/communication devices 2 coupled to a server system 4 via a network 6. Each computing/communication device 2 may be implemented using a general-purpose computer executing a computer program for carrying out the processes described herein. The computing/communication devices 2 may also be, but are not limited to, portable computing devices, wireless devices, personal digital assistants (PDA), cellular devices, etc. The computer program may be resident on a storage medium local to the computing/communication devices 2, or may be stored on the server system 4. The server system 4 may belong to a public service provider, or to an individual business entity or private party. The network 6 may be any type of known network including a local area network (LAN), wide area network (WAN), global network (e.g., Internet), intranet, wireless or cellular network, etc. The computing/communication devices 2 may be coupled to the server system 4 through multiple networks (e.g., intranet and Internet) so that not all computing/communication devices 2 are coupled to the server system 4 via the same network. In a preferred embodiment, the network 6 is a LAN and each computing/communication device 2 executes a user interface application (e.g., web browser) to contact the server system 4 through the network 6. Alternatively, a computing/communication device 2 may be implemented using a device programmed primarily for accessing network 6 such as a remote client. A display means 3 is provided for the user to interact with the activity-centric collaboration program.

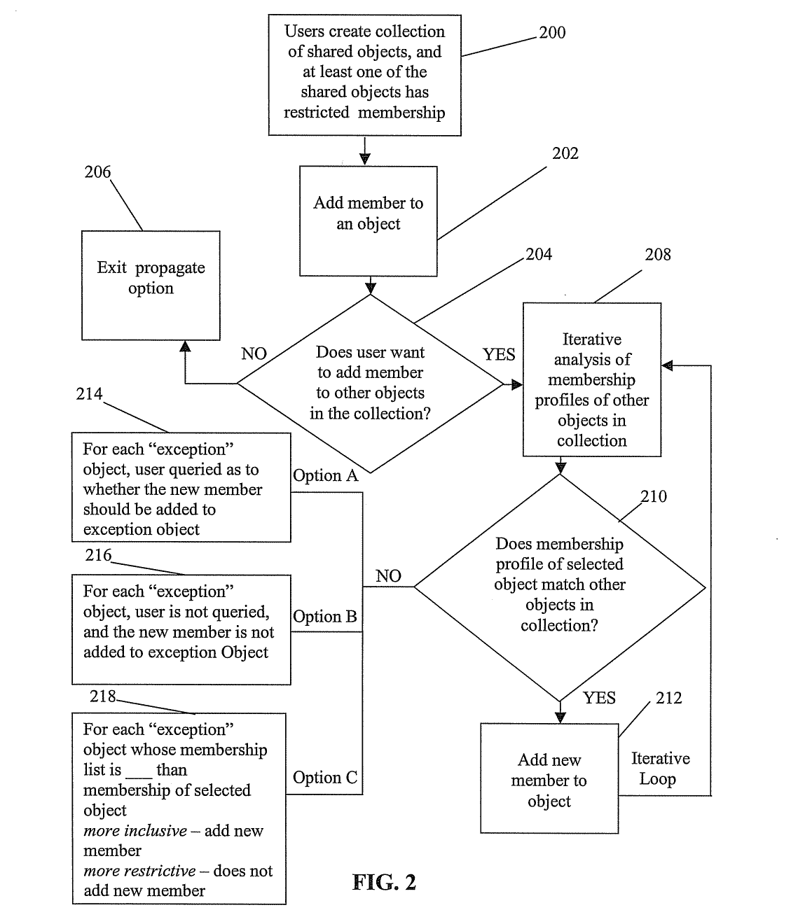

FIG. 2 illustrates a first embodiment of the present invention. A collection of shared objects (200), where at least one of the shared objects has a restricted membership, forms the framework for the environment, which is an electronic activity-centric collaboration program of the present invention. A current member (who has access to an object(s)) of the collection invites a new member (to whom access to an object(s) is to be granted) to join the collection, by executing an add-member operation on one object of the collection, to add the new member to that object (202). The environment offers the option to propagate the add-member operation to other objects in the collection (204). If the current member says no, the propagate option is exited (206). If the current member accepts the “propagate” option, the environment analyzes the membership of the selected object. The environment iteratively analyzes the membership of the other “propagate” objects over which the propagation operation occurs (208); usually the operation is restricted to those objects in which the current member is a member. If the membership of the “propagate” object is the same as the membership of the selected object, the new member is added (210, 212). Otherwise, the “propagate” object is determined to be an “exception” and one of the following options occurs as defined by the environment:

Option A (214):
For each “exception” object, the environment queries the current member as to whether the new member should be added to the exception object

Option B (216):
For each “exception” object, the environment does not add the new member to the exception object (and does not query the Current member).

Option C (218):
For each “exception” object whose membership list is more inclusive than the membership of the selected object, then the environment adds the new member to the exception object.
For each “exception” object whose membership list is more restrictive than the membership of the selected object, then the environment does not add the new member to the exception object.

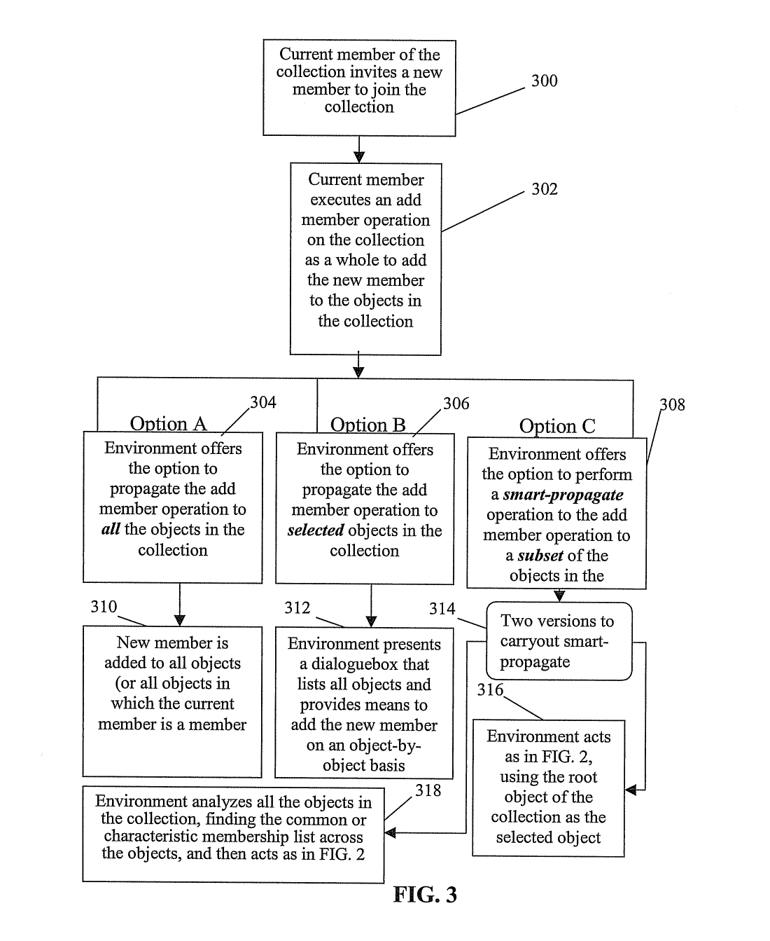

In FIG. 3, a second embodiment of the present invention is illustrated, where a current member of the collection invites a new member to join the collection (300). The current member executes an add-member operation on the collection as a whole, to add the new member to the objects in the collection (302). The environment offers the current member three options on how to propagate the add-member operation:

Option A (304):
The environment offers to propagate the add-member operation to all the objects in the collection. In this instance, the new member is added to all objects (or all objects in which Current member is a member)(3 10).

Option B (306):
The environment offers to propagate the add-member operation to selected objects in the collection. In this instance, the environment presents a dialogue box that lists all objects, and provides a means to add the new member on an object-by-object basis (312). The “means” may be checkboxes, radioboxes, or context menus for each object.

Option C (308):
The environment offers to perform a smart-propagate operation to the add-member operation to a subset of the objects in the collection. In one instance (316), the propagate operation continues as in FIG. 2, using the root object of the collection as the “selected object,” and proceeding through the remaining steps of FIG. 2. In a second instance (318), the environment analyzes all the objects in the collection, finding the common or characteristic membership list across the objects. In one embodiment, this can be accomplished by constructing a table that lists each subset of members, and counts how many objects use each subset of members. The most frequently used subset is defined as the “common” membership list. In a second embodiment, the analysis is carried out by finding the object with the largest number of members. The object with the largest number of members is defined as the “common” membership list. The environment acts as in FIG. 2, using the object with the “common” membership list as the “selected object,” and proceeding through the remaining steps of FIG. 2 to assign membership to objects within the collection to the new member.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for a current member to selectively add a new member to an activity-centric collaboration, where groups of people share a collection of objects, wherein said objects have access control lists; and
wherein said method further comprises an application monitoring the granting of access rights to said objects during execution of new membership to an activity thread or an activity that constitutes the propagation of new membership across multiple objects.

2. The method of claim 1 wherein said access control lists further comprise membership lists; and
wherein said membership lists further comprise a listing that identifies individual members within said groups of people; and
wherein when said user executes a new membership propagate command, said application examines the membership list of the objects in the collection; and
wherein when said application discovers one or more objects whose membership list is different from the membership lists of the other objects, said objects are considered to be exceptional objects to the general pattern of membership; and
wherein said application queries the user as to whether it is desirable to add said new member to each of the said exceptional objects.

3. The method of claim 1 wherein said objects may comprise a file, communications instance, website, artifacts, or documents.

4. The method of claim 1 wherein said objects further comprise public objects and private objects; and
wherein said public objects are available to all of said group of people; and
wherein said private objects are restricted to a subset of said group of people; and
wherein said access control list defines the subset of said group of people with access rights to a particular object.

5. The method of claim 1 wherein said application monitoring the granting of said access rights to said objects during execution of new membership to an activity thread or an activity is conducted in an iterative fashion; and
wherein said iterations are restricted to those objects in which said current member is a member.

6. The method of claim 5 wherein said iterations comprise comparing said access control lists of said objects within said collection of objects to the access control list of the initial object to which said current member adds said new member.

7. The method of claim 6 wherein when said access control list of an object within said collection of objects matches said access control list of said initial object said new member is added to the access control list of said object.

8. The method of claim 6 wherein when said access control list of an object within said collection of objects does not match said access control list of said initial object said new member is not added to the access control list of said object.

9. The method of claim 6 wherein when said access control list of an object within said collection of objects does not match said access control list of said initial object said current member is queried as to whether to add said new member to the access control list of said object.

10. The method of claim 6 wherein when said access control list of an object within said collection of objects matches is more inclusive than said access control list of said initial object said new member is added to the access control list of said object.

11. The method of claim 6 wherein when said access control list of an object within said collection of objects is more restrictive than said access control list of said initial object said new member is not added to the access control list of said object.

12. The method of claim 1 wherein said current member executes an add-member operation on said collection of objects as a whole, to add said new member to the objects in said collection; and
wherein said application offers to propagate the add-member operation to all of the said objects in said collection.

13. The method of claim 1 wherein said current member executes an add-member operation on said collection of objects as a whole, to add said new member to the objects in said collection; and
wherein said application offers to propagate the add-member operation to selected objects in said collection; and
wherein said application provides a selection means to said current member to select which objects to add said new member; and
wherein said selection means comprises a dialogue box; and
wherein said dialogue box further comprises: checkboxes; radioboxes; or context menus for each object.

14. The method of claim 1 wherein said current member executes an add-member operation on said collection of objects as a whole, to add said new member to the objects in said collection; and
wherein said application offers to smart-propagate the add-member operation to selected objects in said collection; and
wherein said smart-propagate operation comprises said application taking a root object and using said root object as a comparison tool to determine which objects are appropriate to add said new member.

15. The method of claim 1 wherein said current member executes an add-member operation on said collection of objects as a whole, to add said new member to the objects in said collection; and
wherein said application offers to smart-propagate the add-member operation to selected objects in said collection; and
wherein said smart-propagate operation comprises said application analyzing all the objects in said collection, and determining the common or characteristic membership list across said objects; and
wherein said common or characteristic membership list is used to assign appropriate objects to said new member.

16. The method of claim 16 wherein said common or characteristic membership list is determined by constructing a table that lists each subset of members; and
wherein said application counts how many objects use each subset of members; and
wherein the most frequently used subset is defined as said common or characteristic membership list; and
wherein said common or characteristic membership list is used to assign appropriate objects to said new member.

17. The method of claim 16 wherein said common or characteristic membership list is determined by said application finding the object with the largest number of members; and
wherein the object with the largest number of members is defined as said common or characteristic membership list; and
wherein said common or characteristic membership list is used to assign appropriate objects to said new member.

18. An article comprising one or more machine-readable storage media containing instructions that when executed enable a processor to access an electronic activity-centric collaboration program; and
wherein said activity-centric collaboration program facilitates groups of people to share a collection of objects; and
wherein said objects have access control lists; and
wherein said activity-centric collaboration program enables a user to monitor the granting of access rights to objects and files during the execution of new membership to an Activity Thread or an Activity, which constitutes the propagation of the new membership across multiple objects.

19. The article of claim 11 wherein said access control lists further comprise membership lists; and
wherein said membership lists further comprise a listing that identifies individual members within said groups of people; and
wherein when said user executes a new membership propagate command, said activity-centric collaboration program examines the membership list of the objects in the collection; and
wherein when said activity-centric collaboration program discovers one or more objects whose membership list is different from the membership lists of the other objects, said objects are considered to be exceptional objects to the general pattern of membership; and
wherein said activity-centric collaboration program queries the user as to whether it is desirable to add said New member to each of the said exceptional objects.

20. A system for activity-centric collaboration, said system comprising:
at least one collaboration device;
a server system;
at least one network; and
wherein said collaboration device is implemented using a general-purpose computer executing electronic software that manages objects or file structures with conditional or rights access; and
wherein said electronic software is resident on a storage medium; and
wherein said collaboration device has the ability to be coupled to said server system via said network; and
wherein said collaboration device has a display means; and
wherein said electronic software interacts with a user via said display means; and
wherein said electronic software provides a means for a current member to selectively add a new member to said activity-centric collaboration, where groups of people share a collection of objects, wherein said objects have access control lists; and
wherein said electronic software further comprises an application monitoring the granting of access rights to said objects during execution of new membership to an activity thread or an activity that constitutes the propagation of new membership across multiple objects.
